(19) United States
(12) Patent Application Publication
(10) Pub. No.: US 2025/0037593 A1
(43) Pub. Date: Jan. 30, 2025

(54) Scholastic Mark Prediction System, Scholastic Mark Prediction Method, and Non-Transitory Computer-Readable Recording Medium

(71) Applicant: Konica Minolta, Inc., Tokyo (JP)

(72) Inventors: Chikako TAKIGAMI, Takarazuka-shi (JP); Yuma ARATAKE, Kyoto-shi (JP)

(21) Appl. No.: 18/750,612

(22) Filed: Jun. 21, 2024

(30) Foreign Application Priority Data
Jul. 26, 2023 (JP) 2023-121763

(51) Int. Cl. G09B 5/02; G06Q 50/20; G09B 5/14; G09B 7/02

(52) U.S. Cl. CPC G09B 5/02; G06Q 50/205; G09B 5/14; G09B 7/02

(57) ABSTRACT

A scholastic mark prediction system for a learning curriculum, in which a plurality of learning items are assigned to a plurality of levels and learning is performed in order of the levels, includes a hardware processor. The hardware processor extracts, based on relevance information indicating relevance between the plurality of learning items, learning information on a learning item out of learning information on a target learner, the learning item being relevant to a learning item subjected to prediction, among the plurality of learning items, and being assigned to a preceding level that precedes a level to which the learning item subjected to prediction is assigned. The hardware processor predicts, based on the extracted learning information, a scholastic mark of the target learner for the learning item subjected to prediction, and outputs a result of the prediction.

### CROSS-REFERENCE TO RELATED APPLICATIONS

The entire disclosure of Japanese Patent Application No. 2023-121763, filed on Jul. 26, 2023, is incorporated herein by reference in its entirety.

### BACKGROUND OF THE INVENTION

### Technical Field

The present disclosure relates to a technology for predicting scholastic marks, and more particularly, to a technology for predicting a scholastic mark before a test is performed.

### Description of Related Art

Conventionally, it is possible to know learning items (units of study) which each student is not good at, by a scholastic achievement test. Regarding prediction of the scholastic ability, for example, Japanese Laid-Open Patent Publication No. 2023-027458 discloses “an evaluation program capable of performing objective learning evaluation including not only scholastic ability but also other aspects related to learning” (see [Abstract]).

Japanese Laid-Open Patent Publication No. 2021-113892 discloses “a learning effect estimation device capable of estimating a user's learning effect by reflecting various aspects of a mechanism by which a human understands things” (see [Abstract]).

Japanese Laid-Open Patent Publication No. 2020-166816 discloses “a technology for prompting a participant of a course to take a desirable action for passing a test” (see [Abstract]).

### SUMMARY OF THE INVENTION

However, when working on learning, it is effective for a learner to know, at an early stage, areas of study that the learner is not good at, and take a countermeasure, and it is desired to predict the scholastic ability of the learner, before a scholastic achievement test is conducted. Therefore, there is a need for a technology for predicting the scholastic ability.

The present disclosure is made in view of the above-described background, and an object according to an aspect is to provide a technology for appropriately predicting the scholastic ability.

To achieve at least one of the abovementioned objects, according to an aspect of the present invention, a scholastic mark prediction system for a learning curriculum in which a plurality of learning items are assigned to a plurality of levels and learning is performed in order of the levels, reflecting one aspect of the present invention, comprises a hardware processor. The hardware processor performs: extracting, based on relevance information indicating relevance between the plurality of learning items, learning information on a learning item out of learning information on a target learner, the learning item being relevant to a learning item subjected to prediction, among the plurality of learning items, and being assigned to a preceding level that precedes a level to which the learning item subjected to prediction is assigned; and predicting, based on the extracted learning information, a scholastic mark of the target learner for the learning item subjected to prediction, and outputting a result of the prediction.

To achieve at least one of the abovementioned objects, according to another aspect of the present invention, a scholastic mark prediction method implemented by a computer, reflecting one aspect of the present invention, comprises: accessing, by a hardware processor of the computer, a learning curriculum in which a plurality of learning items are assigned to a plurality of levels and learning is performed in order of the levels; extracting, by the hardware processor, based on relevance information indicating relevance between the plurality of learning items, learning information on a learning item out of learning information on a target learner, the learning item being relevant to a learning item subjected to prediction, among the plurality of learning items, and being assigned to a preceding level that precedes a level to which the learning item subjected to prediction is assigned; and predicting, by the hardware processor, based on the extracted learning information, a scholastic mark of the target learner for the learning item subjected to prediction, and outputting, by the hardware processor, a result of the prediction.

To achieve at least one of the abovementioned objects, according to still another aspect of the present invention, a non-transitory computer-readable recording medium reflecting one aspect of the present invention, has a program stored thereon for causing a computer to perform the scholastic mark prediction method.

The above and other objects, features, aspects and advantages of the present invention will become apparent from the following detailed description of the present invention which is to be understood in conjunction with the accompanying drawings.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram illustrating a schematic configuration of a system 10.

FIG. 2 is a block diagram illustrating a hardware configuration of a computer device 200 that functions as an information processing device.

FIG. 3 is a block diagram illustrating a configuration of functions of a server device 100.

FIG. 4 is a diagram illustrating an outline of a scholastic mark prediction model 331.

FIG. 5 is a flowchart illustrating a part of processing executed by a CPU 1 functioning as a model generation unit 321.

FIG. 6 is a flowchart illustrating a part of processing executed by the CPU 1 functioning as a scholastic mark prediction unit 322.

FIG. 7 is a diagram illustrating each unit of study of “arithmetic” for each grade among the third grade to the sixth grade of the elementary school.

FIG. 8 is a diagram illustrating a manner of storing data in a storage device 5 included in the computer device 200 serving as the server device 100.

FIG. 9 is a flowchart (part 1) illustrating apart of processing executed by the CPU 1 of the server device 100.

FIG. 10 is a flowchart (part 2) illustrating apart of the processing executed by the CPU 1 of the server device 100.

FIG. 11 is a flowchart (part 3) illustrating a part of the processing executed by the CPU 1 of the server device 100.

FIG. 12 is a diagram (part 1) illustrating a screen displayed on a monitor 8 of a teacher terminal 130.

FIG. 13 is a diagram (part 2) illustrating a screen displayed on the monitor 8 of the teacher terminal 130.

FIG. 14 is a diagram illustrating a screen displayed on a monitor 8 of a learner terminal 140.

### DETAILED DESCRIPTION

Hereinafter, one or more embodiments of the present invention will be described with reference to the drawings. However, the scope of the invention is not limited to the disclosed embodiments.

In the following description, the same components are denoted by the same reference characters. They have the same name and they also have the same function. Therefore, the detailed description thereof will not be repeated.

### <Outline of System>

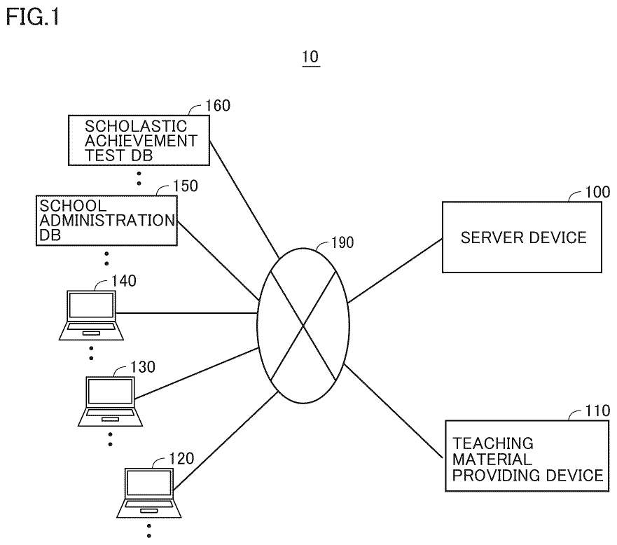

Referring to FIG. 1, a system 10 according to the present embodiment will be described. FIG. 1 is a diagram illustrating a schematic configuration of the system 10. As illustrated in FIG. 1, the system 10 includes a server device 100, a teaching material providing device 110, a scholastic achievement test database (DB) 160, a school administration database (DB) 150, an administrator terminal 120, a teacher terminal 130, and a learner terminal 140. In an aspect, the server device 100 can cause the administrator terminal 120, the teacher terminal 130, and the learner terminal 140 to display the scholastic mark and other information in response to a request.

In an aspect, the system 10 can be configured as a system that provides a cloud service. In this case, in one example, the administrator terminal 120, the teacher terminal 130, and the learner terminal 140 can receive displaying information and other cloud services. In this case, the server device 100 provides displaying information and other cloud services to the administrator terminal 120, the teacher terminal 130, and the learner terminal 140.

Furthermore, in an aspect, from the viewpoint of security such as personal information protection, an operation of handling personal information such as an operation of predicting a scholastic mark is performed in an information processing device within an intranet rather than in a cloud environment, or managed and operated on premises.

The server device 100, the teaching material providing device 110, the scholastic achievement test DB 160, the school administration DB 150, the administrator terminal 120, the teacher terminal 130, and the learner terminal 140 can communicate with each other via a network 190. The network 190 may be, for example, a public network such as the Internet, a public line, or a public wireless local area network (LAN), or may be a private network such as a LAN or a virtual private network (VPN).

The administrator terminal 120 is used by, for example, an administrator who manages school operation. The teacher terminal 130 is used by a teacher. The learner terminal 140 is used by a learner. Each of the administrator terminal 120, the teacher terminal 130, and the learner terminal 140 is, for example, a general-purpose computer device such as a desktop computer, a notebook computer, a smartphone, or a tablet. The administrator terminal 120 is provided, for example, for each school. The system 10 includes a plurality of teacher terminals 130 corresponding to the number of teachers, and includes a plurality of learner terminals 140 corresponding to the number of learners.

The teaching material providing device 110 is an information providing device that provides a cloud service. More specifically, the teaching material providing device 110 receives an instruction from the learner terminal 140 and provides a specified teaching material to the learner terminal 140. The teaching material includes, for example, a calculation workbook, a Kanji character workbook, or the like.

Upon receiving an access request from the learner terminal 140, the teaching material providing device 110 provides a login screen to the learner terminal 140. The learner inputs a learner identification (ID) and a password for identifying the learner to the login screen. When the teaching material providing device 110 confirms that the learner ID and the password input to the login screen match information registered in advance, the teaching material providing device 110 provides a teaching material selection screen to the learner terminal 140. The teaching material providing device 110 provides the learner terminal 140 with the teaching material corresponding to the input one to the selection screen.

For example, when the teaching material is a calculation workbook, the learner inputs an answer to the learner terminal 140. The teaching material providing device 110 performs scoring by collating the answer input to the learner terminal 140 with the correct answer stored in advance, and transmits the result of the scoring to the learner terminal 140.

Each time the teaching material providing device 110 provides a teaching material, the teaching material providing device 110 accumulates teaching material providing data indicating the following items. Note that the teaching material providing device 110 accumulates the period from the time when teaching material provision is started to the time when the teaching material provision is ended, as a learning time.
A learner ID identifying a learner who was provided with a teaching material;
The date and time when the teaching material was provided;
A type of the teaching material;
A teaching guideline code corresponding to the teaching material; and
Learning time for which the provided teaching material was used.

The teaching guidelines are criteria for a curriculum that are defined by the Ministry of Education, Culture, Sports, Science and Technology. At each school, education is carried out in accordance with the teaching guidelines. The teaching guidelines are defined for each school type, and define matters to be learned for each course of study for each grade. Specifically, the teaching guidelines define “goal”, “content”, and “handling of content” for each course of study. The “content” includes one or more “fields”. Furthermore, the teaching guidelines define, for an item to be learned, which of a plurality of “viewpoints” that are important elements in school-education corresponds to the item. The plurality of “viewpoints” include “knowledge and skill” and “thinking, determination, and expression”.

Respective teaching guideline codes are assigned to all items of the teaching guidelines for all types of schools. Therefore, a school type, a grade, a course of study, a content, a field, handling of the content, a viewpoint, or the like can be specified by the teaching guideline code.

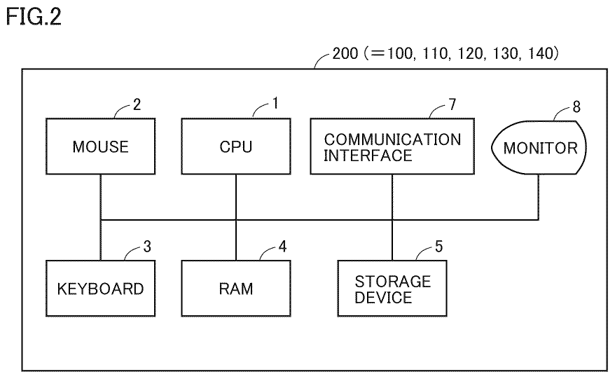

With reference to FIG. 2, a specific configuration of an information processing device that implements the server device 100, the teaching material providing device 110, the administrator terminal 120, the teacher terminal 130, and the learner terminal 140 will be described. FIG. 2 is a block diagram illustrating a hardware configuration of a computer device 200 that functions as an information processing device.

The computer device 200 includes, as main constituent elements, a CPU 1 that executes a program, a mouse 2 and a keyboard 3 that receive input of an instruction from a user of the computer device 200, a RAM 4 that stores, in a volatile manner, data generated by execution of the program by the CPU 1 or data input via the mouse 2 or the keyboard 3, a storage device 5 that stores data in a nonvolatile manner, a communication interface (I/F) 7, and a monitor 8. These constituent elements are connected to one another by a data bus. The storage device 5 is implemented by a hard disk device, a solid state drive (SSD) device, or the like.

Processing in the computer device 200 is implemented by cooperation of hardware and software executed by the CPU 1. Such software nay be stored in the storage device 5 in advance. In addition, the software may be stored in a compact disc-read only memory (CD-ROM) or another recording medium and distributed as a computer program. The CD-ROM or the other recording medium is an example of “a non-transitory computer-readable recording medium” in the present disclosure. Alternatively, the software may be provided as a downloadable application program by an information provider connected to the so-called Internet. Such software is temporarily stored in the storage device 5 after being read from the recording medium by an optical disk drive device (not shown) or another reading device, or after being downloaded via the communication interface 7. The software is read from the storage device 5 by the CPU 1 and stored in the form of a program executable by the RAM 4. The CPU 1 executes the program.

Each of the constituent elements constituting the computer device 200 shown in FIG. 2 is a general constituent element. Therefore, one of the essential aspects of the technical idea according to the present disclosure is also considered as software stored in the RAM 4, the storage device 5, a CD-ROM or another recording medium, or software downloadable via a network. The recording medium may include a non-transitory (non-volatile) computer-readable data recording medium. Note that since the operation of each piece of hardware of the computer device 200 is well known, detailed description will not be repeated.

Note that the recording medium is not limited to CD-ROM, FD (Flexible Disk), and a hard disk, but may be a recording medium that carries a program in a fixed manner, such as a magnetic tape, a cassette tape, an optical disc (MO (Magnetic Optical Disc)/MD (Mini Disc)/DVD (Digital Versatile Disc)), an integrated circuit (IC) card (including memory card), an optical card, a Mask ROM, an EPROM (Electronically Programmable Read-Only Memory), an EEPROM (Electronically Erasable Programmable Read-Only Memory), a flash ROM, or the like.

The program herein includes not only a program directly executable by the CPU but also a program in a source program format, a compressed program, an encrypted program, and the like.

### [Functional Configuration]

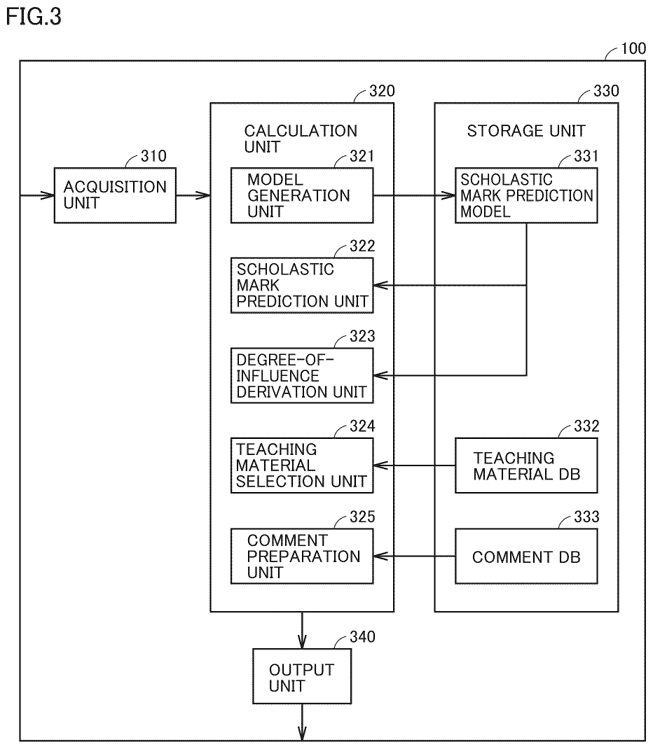

With reference to FIG. 3, a configuration of the server device 100 will be described FIG. 3 is a block diagram illustrating a configuration of functions of the server device 100.

The server device 100 includes an acquisition unit 310, a calculation unit 320, and a storage unit 330. The calculation unit 320 includes a model generation unit 321, a scholastic mark prediction unit 322, a degree-of-influence derivation unit 323, a teaching material selection unit 324, and a comment preparation unit 325. The storage unit 330 includes a scholastic mark prediction model 331, a teaching material DB (database) 332, and a comment DB 333.

The acquisition unit 310 acquires, from the scholastic achievement test DB 160, a status of learning (test results, scholastic marks, status of progress of learning, such as learning with teaching materials) for a learning item assigned to a preceding level (preceding grade) associated with a learning item (subject, unit of study) for which a scholastic mark of each student is to be predicted. In an aspect, based on relevance information indicating relevance between a plurality of learning items, the acquisition unit 310 extracts, from the scholastic achievement test DB 160, learning information on a learning item out of learning information on a target learner, the learning item being relevant to a learning item subjected to prediction, among the plurality of learning items, and being assigned to a preceding level that precedes a level to which the learning item subjected to prediction is assigned.

The calculation unit 320 executes processing such as recording of scholastic marks, generation of a learning model, prediction of scholastic marks, preparation of comments, and generation of display data, based on data acquired from the outside and data stored in the storage unit 330.

More specifically, the model generation unit 321 generates a model (the scholastic mark prediction model 331) obtained by learning, for each of a plurality of students, a status of learning of a unit of study of a preceding level relevant to a target unit-of-study, as well as the scholastic mark of the target unit-of-study. The scholastic mark prediction model 331 is held in the storage unit 330.

The scholastic mark prediction unit 322 predicts, using the scholastic mark prediction model 331, a scholastic mark of the target unit-of-study, from the status of learning by a target student for the unit of study of the preceding level. In one example, the scholastic mark prediction unit 322 predicts a scholastic mark of a target learner for a learning item subjected to prediction, based on the extracted learning information, and outputs the result of the prediction.

The degree-of-influence derivation unit 323 calculates a degree of influence of each piece of information on the result of prediction of the scholastic mark. For example, the degree-of-influence derivation unit 323 calculates, using an algorithm prepared in advance, the degree of influence that a plurality of pieces of information included in the status of learning for each grade have on the prediction result.

The teaching material selection unit 324 selects a teaching material appropriate for the scholastic mark from the teaching material DB 332. The comment preparation unit 325 reads a comment from the comment DB 333 and prepares a comment appropriate for the target student.

The teaching material DB 332 holds data of a teaching material prepared in advance. Comment DB 333 holds comment data serving as a material for providing a comment appropriate for each student. A comment is generated by the comment preparation unit 325 in accordance with one or more pieces of comment data, and the student's scholastic mark and status of learning.
(1) In an aspect, the CPU 1 extracts, based on relevance information indicating relevance between the plurality of learning items, learning information on a learning item out of learning information on a target learner, the learning item being relevant to a learning item subjected to prediction, among the plurality of learning items, and being assigned to a preceding level that precedes a level to which the learning item subjected to prediction is assigned. The CPU 1 predicts, based on the extracted learning information, a scholastic mark of the target learner for the learning item subjected to prediction, and outputs a result of the prediction.
(2) In an aspect, the CPU 1 inputs the extracted learning information to a learning model, to predict the scholastic mark of the target learner for the learning item subjected to prediction, where the learning model is generated for each of a plurality of learners, by learning a relation between: the learning information on the learning item that is relevant to the learning item subjected to prediction and that is assigned to the preceding level that precedes the level to which the learning item subjected to prediction is assigned; and the scholastic mark of the learner for the learning item subjected to prediction.
(3) In an aspect, the CPU 1 predicts the scholastic mark for the learning item by using information for each unit of study as the learning information.
(4) In an aspect, the CPU 1 predicts the scholastic mark for each learning item defined by a teaching guideline code.
(5) In an aspect, the CPU 1 generates, as the result of the prediction, at least one of: information indicating whether the scholastic mark of the target learner is higher than a predetermined standard, information indicating a possibility that the scholastic mark of the target learner is higher than the predetermined standard, and information indicating a degree of understanding, by the target learner, of the learning item subjected to prediction. The information indicating the degree of understanding is a percentage of correct answers, for example. The generated information differs depending on an algorithm used for a prediction model used for the generation.
(6) In an aspect, the learning information is made up of a plurality of pieces of information. The CPU 1 detects information regarding a degree of influence of the information on the result of the prediction, and outputs the detected information.
(7) In an aspect, the CPU 1 outputs, based on the information regarding the degree of influence, a comment or information regarding a teaching material.

Each of the above-described operations is executed by the CPU 1 of the computer device 200 managed and operated within an intranet or managed and operated on premises. Note that in another example, the operations may be executed in a cloud environment in which security is guaranteed.
(8) In an aspect, the CPU 1 generates, for the learning item, data for presenting the result of the prediction for the target learner, and an actual value of the scholastic mark of the target learner, in a manner that the result of the prediction and the actual value can be compared with each other. In one example, this operation is executed by the CPU 1 of the computer device 200 in a cloud environment.
(9) In an aspect, the CPU 1 generates, for the learning item, information based on the result of the prediction for the target learner and an actual value of the scholastic mark of the target learner, and presents the generated information. In one example, this operation is executed by the CPU 1 of the computer device 200 in a cloud environment.
(10) In an aspect, the learning item for the preceding level includes a learning item of a course of study different from a course of study of the learning item subjected to prediction.

### [Model]

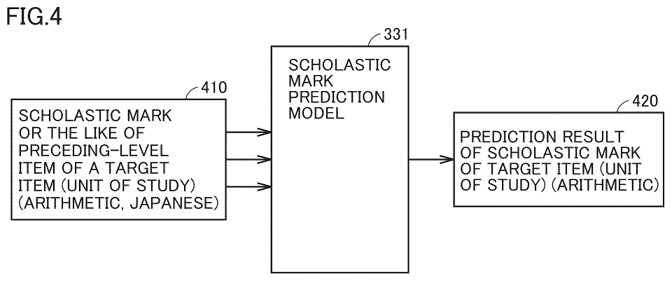

The scholastic mark prediction model 331 will be described with reference to FIG. 4. FIG. 4 is a diagram illustrating an outline of the scholastic mark prediction model 331. The scholastic mark prediction model 331 outputs a prediction result 420 based on an input 410. The input 410 is data of a scholastic mark of the preceding level of a target item (for each unit of study). The target item is defined for each unit of study specified in the teaching guidelines, such as arithmetic, Japanese or the like, for example. The prediction result 420 is a result of prediction of the scholastic mark of the target item.

In an aspect, when a scholastic mark, a test result, and a status of working on a teaching material for a unit of study of the arithmetic for the preceding level are input, for a learner, as the input 410 to the scholastic mark prediction model 331, the scholastic mark prediction model 331 outputs a prediction result 420 of a future scholastic mark. In another aspect, when the scholastic mark prediction model 331 learns the scholastic mark of one subject (e.g., arithmetic) from a status of learning of a plurality of subjects (e.g., arithmetic and Japanese), the scholastic mark prediction model 331 may output the prediction result 420 of the future scholastic mark of one subject (e.g., arithmetic), based on the input 410 of the plurality of subjects (e.g., arithmetic and Japanese).

### [Model Generation]

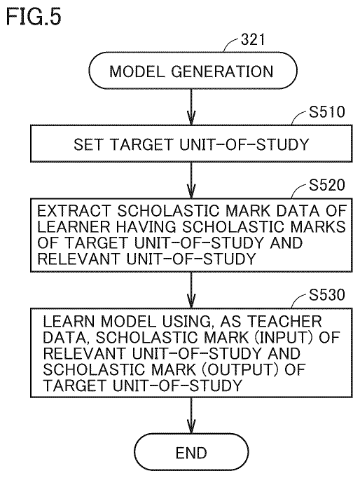

Processing by the model generation unit 321 will be described with reference to FIG. 5. FIG. 5 is a flowchart illustrating a part of processing executed by the CPU 1 functioning as the model generation unit 321.

In step S510, the CPU 1 sets a target unit-of-study based on an input by a user of the system 10.

In step S520, the CPU 1 extracts scholastic mark data of a learner having the scholastic marks of the target unit-of-study and a relevant unit-of-study, from the scholastic achievement test DB 160.

In step S530, the CPU 1 learns a model (the scholastic mark prediction model 331), using the scholastic mark of the relevant unit-of-study and the scholastic mark of the target unit-of-study as teacher data.

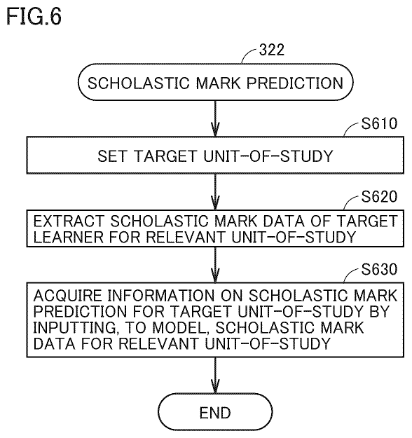

Processing by the scholastic mark prediction unit 322 will be described with reference to FIG. 6. FIG. 6 is a flowchart illustrating a part of processing executed by the CPU 1 functioning as the scholastic mark prediction unit 322.

In step S610, the CPU 1 sets a target unit-of-study based on an input by a user of the system 10.

In step S620, the CPU 1 extracts scholastic mark data of a target learner for a relevant unit-of-study. In step S630, the CPU 1 inputs the scholastic mark data (the input 410) of the relevant unit-of-study to the model (the scholastic mark prediction model 331) and acquires the prediction result 420 of the scholastic mark of the target unit-of-study.

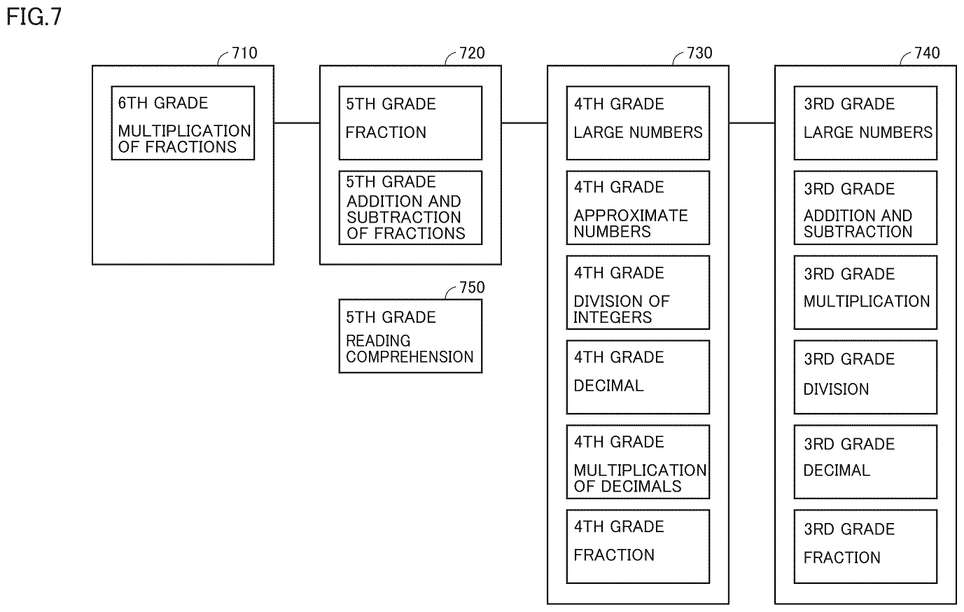

A relevance between target subjects will be described with reference to FIG. 7. FIG. 7 is a diagram illustrating each unit of study of “arithmetic” for each grade among the third grade to the sixth grade of the elementary school.

A block 710 illustrates “Multiplication of Fractions” which is apart of units of study of the arithmetic for the sixth grade. A block 720 illustrates “Fraction” and “Addition and Subtraction of Fractions” which are a part of units of study of the arithmetic for the fifth grade.

A block 730 illustrates “Large Numbers”, “Approximate Numbers”, “Division of Integers”, “Decimal”, “Multiplication of Decimals”, and “Fraction”, which are a part of units of study of the arithmetic for the fourth grade.

A block 740 illustrates “Large Numbers”, “Addition and Subtraction”, “Multiplication”, “Division”, “Decimal”, and “Fraction” which are a part of units of study of the arithmetic for the third grade.

Furthermore, scholastic marks of a plurality of subjects (e.g., arithmetic and Japanese) for the preceding level (e.g., the grade before promotion) may affect a scholastic mark of a single subject (e.g., arithmetic) for a target level (the grade after promotion). Therefore, in another aspect, a block 750 may further be associated with the target subject (arithmetic). In an example, the block 750 illustrates “reading comprehension” that is a part of units of study of another subject (Japanese) among a plurality of subjects for the preceding level (i.e., fifth grade) preceding the sixth grade. They can be stored in the server device 100.

### [Data Structure]

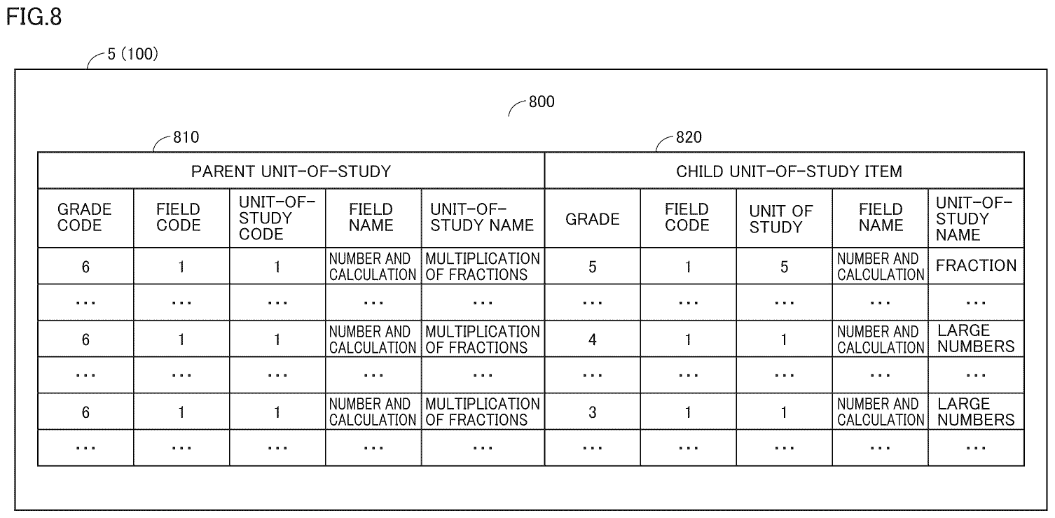

A data structure of the server device 100 will be described with reference to FIG. 8. FIG. 8 is a diagram illustrating a manner of storing data in the storage device 5 included in the computer device 200 serving as the server device 100.

The storage device 5 holds a table 800. The table 800 includes a parent unit of study 810 and a child unit-of-study item 820. Each of the unit of study 810 and the unit-of-study item 820 includes a grade code, a field code, a unit-of-study code, a field name, and a unit-of-study name. The grade code represents a grade. The field code identifies a field covering details of one or more units of study. The unit-of-study code identifies each unit of study.

The field name is the name of the field. The unit-of-study name is the name of the unit of study.

### [Control Structure of Server Device]

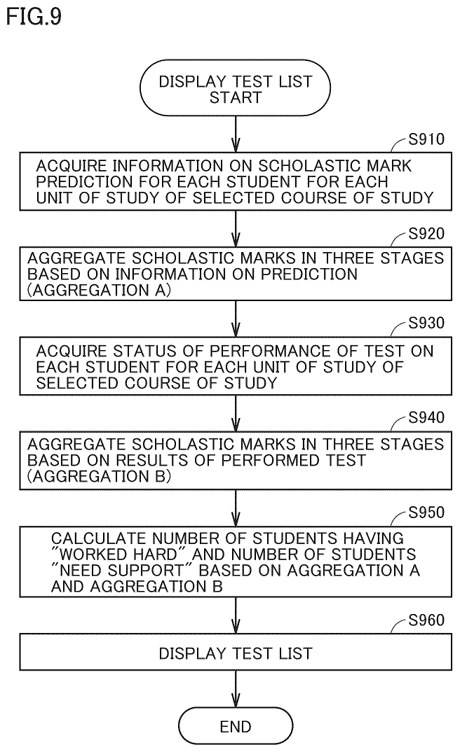

A control structure of the server device 100 will be described with reference to FIGS. 9 to 11. FIGS. 9 to 11 are flowcharts each illustrating a part of processing executed by the CPU 1 of the server device 100. The CPU 1 of the server device 100 is an example of “hardware processor” in the present disclosure. In an aspect, the server device 100 is in a cloud environment, and can provide the teacher terminal 130 or the learner terminal 140 with aggregation and display of scholastic marks and other information processing services, as cloud services.

In step S910, the CPU 1 acquires, from the scholastic achievement test DB 160, a result of prediction of the scholastic mark of each student for each unit of study of a selected course of study. In one example, the result of prediction was acquired in advance using the scholastic mark prediction model 331 and accumulated in scholastic achievement test DB 160. In this case, the result of prediction in the scholastic achievement test DB 160 is anonymized and imported to the server device 100. In the present embodiment, anonymization refers to associating a login ID used for logging into the cloud service with a result of prediction so that the real name of a student associated with the result of prediction will not be recognized. Note that the associated information is not limited to the login ID.

In step S920, the CPU 1 aggregates scholastic marks in three stages based on the result of prediction (aggregation result A). Note that the number of stages for classification is not limited to three, but nay be two, four, or more. Alternatively, in another aspect, the CPU 1 may present the result of prediction as it is, without aggregating the scholastic marks.

In step S930, the CPU 1 acquires a status of performance of a test on each student for each unit of study of a selected course of study.

In step S940, the CPU 1 aggregates the scholastic marks in three stages based on the results of tests having been performed (aggregation result B).

In step S950, the CPU 1 calculates the number of students who have “worked hard” and the number of students who “need support” based on the aggregation result A and the aggregation result B.

In step S960, the CPU 1 displays a test list on the monitor 8 of the administrator terminal 120. A user of the administrator terminal 120 (e.g., a person in charge of a certain class of the sixth grade) can check the status of the scholastic ability of each student in the list.

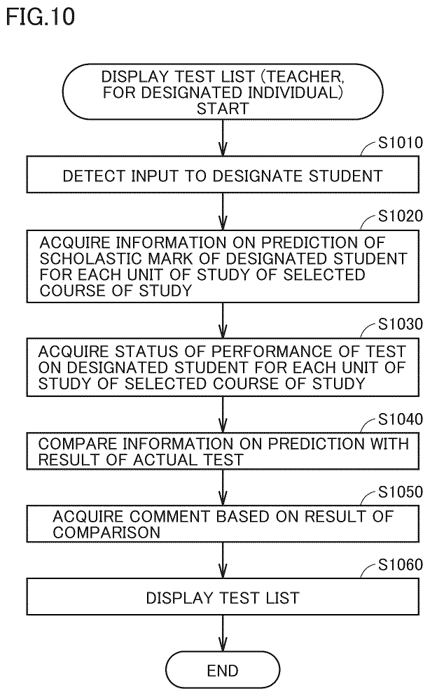

Referring to FIG. 10, in step S1010, the CPU 1 detects an input to designate a student.

In step S1020, the CPU 1 acquires, from the scholastic achievement test DB 160, a prediction result of the designated student's scholastic mark for each unit of study of a selected course of study.

In step S1030, the CPU 1 acquires a status of performance of a test on the designated student for each unit of study of the selected course of study.

In step S1040, the CPU 1 compares the prediction result with an actual test result. In step S1050, the CPU 1 acquires a comment based on a result of the comparison. In an embodiment, the server device 100 holds a plurality of comments. Each comment is prepared in advance for each result that is assumed in advance as a result of comparison between the prediction result and the actual test result.

In step S1060, the CPU 1 displays a test list on the monitor 8 of the administrator terminal 120. Thus, a user of the teacher terminal 130 can provide an advice to the student while checking an appropriate comment on the monitor 8, depending on the test result of each student. As a result, even an inexperienced teacher can give an appropriate advice like an experienced teacher.

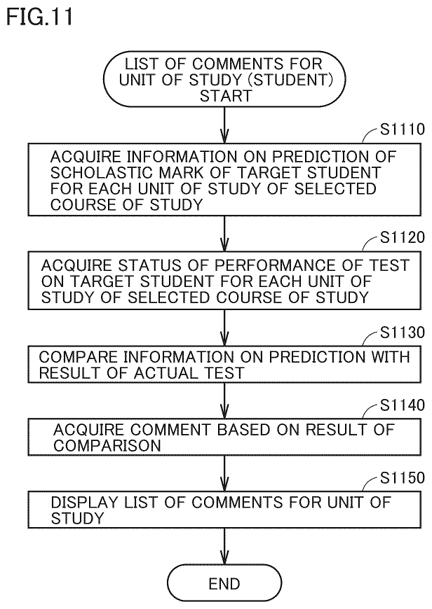

The processing illustrated in FIG. 11 is performed when a user (student) of the learner terminal 140 accesses a website of a school.

In step S1110, the CPU 1 acquires, from the scholastic achievement test DB 160, a result of prediction of a scholastic mark of the target student for each unit of study of a selected course of study. The target student is identified by the user ID of the user of the learner terminal 140 accessing the server device 100.

In step S1120, the CPU 1 acquires, from the scholastic achievement test DB 160, a status of performance of a test on the target student for each unit of study of the selected course of study.

In step S1130, the CPU 1 compares the prediction result with the actual test result. In step S1140, the CPU 1 acquires a comment based on a result of the comparison.

In step S1150, the CPU 1 displays a list of comments for each unit of study on the monitor 8 of the learner terminal 140. Thus, the student can confirm an appropriate comment.

### Screen Examples

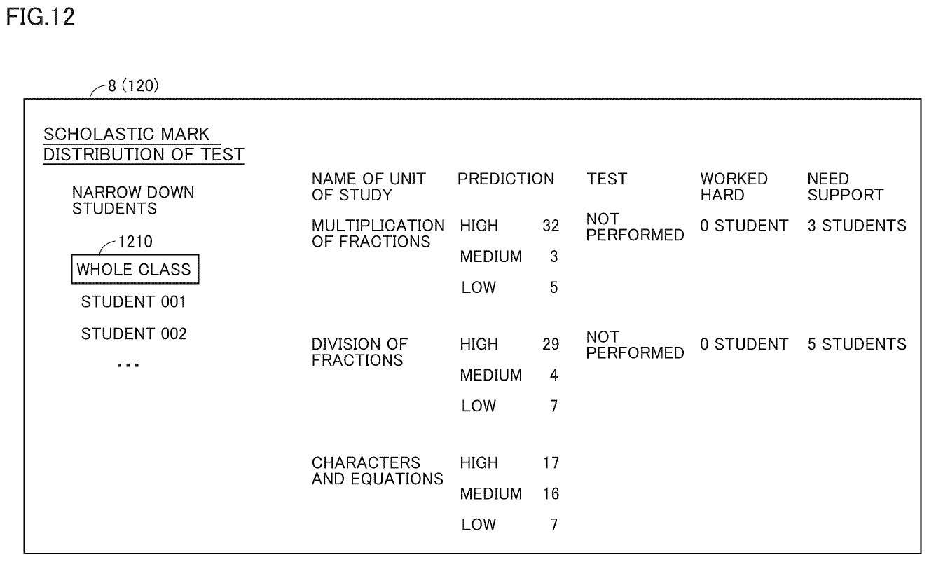

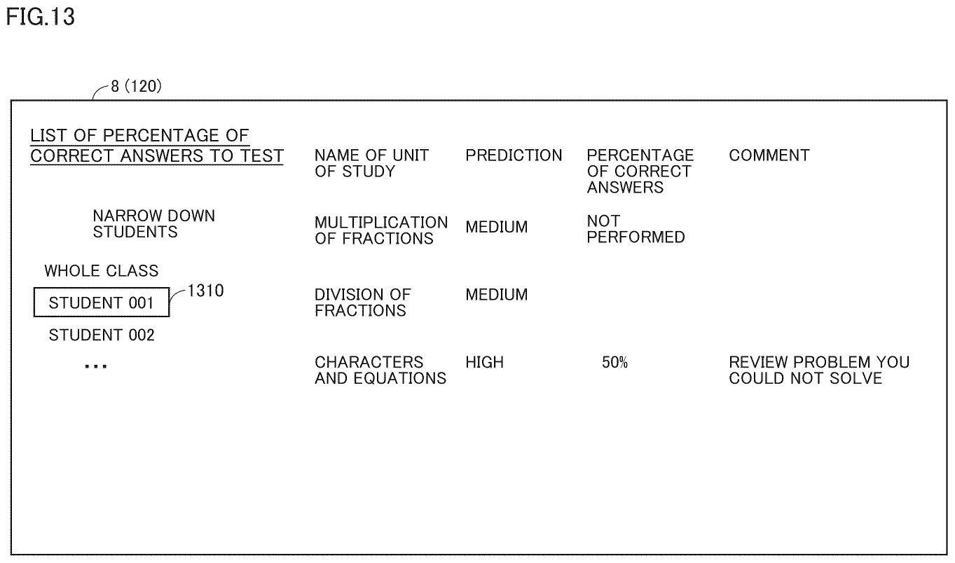

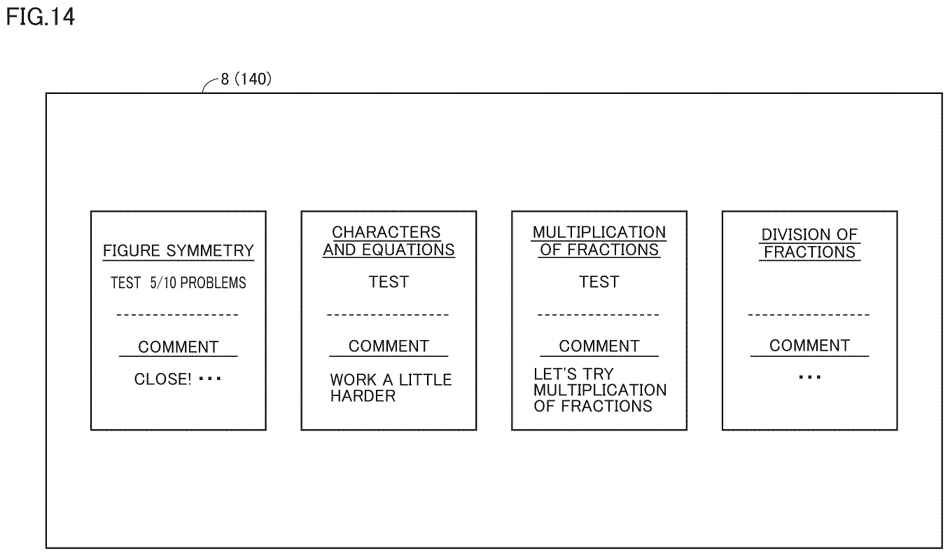

Screen examples displayed on the monitor 8 will be described with reference to FIGS. 12 to 14. FIGS. 12 and 13 are each a diagram illustrating a screen displayed on the monitor 8 of the teacher terminal 130. FIG. 14 is a diagram illustrating a screen displayed on the monitor 8 of the learner terminal 140.

Referring to FIG. 12, the monitor 8 displays a scholastic mark distribution of an achievement test. A teacher who is a user of the teacher terminal 130 can narrow down display targets on the screen displayed on the monitor 8.

In the illustration of FIG. 12, the whole class has been selected, as indicated in a block 1210. In this case, for each unit of study (multiplication of fractions, division of fractions, characters and equations), the results of prediction of scholastic marks by artificial intelligence (AI), a status of performance of the test, the number of students who have worked hard (the scholastic mark has been improved), and the number of students who need support (the scholastic mark has not been improved) are displayed.

With reference to FIG. 13, the monitor 8 displays a list of the percentage of correct answers to the achievement test for a designated student. When the teacher who is the user of the teacher terminal 130 narrows down the display targets to the student with Number 001 on the screen displayed on the monitor 8, the result of the achievement test for the selected student is displayed as indicated in a block 1310. In this case, for each unit of study (multiplication of fractions, division of fractions, characters and equations), a result of prediction of the scholastic mark by the AI, the percentage of correct answers, and a comment from the AI are displayed.

With reference to FIG. 14, the monitor 8 of the learner terminal 140 displays, for a student who is a user of the terminal, a result of an achievement test for each unit of study and a comment from the AI.

As described above, the system 10 according to the present embodiment can be used to predict, based on the status of learning in grades preceding the current grade of the student, the scholastic mark (scholastic ability) of the student in the current grade, and to output a comment appropriate for the student.

Although embodiments of the present invention have been described and illustrated in detail, the disclosed embodiments are made for purposes of illustration and example only and not limitation. The scope of the present invention should be interpreted by terms of the appended claims.

What is claimed is:

1. A scholastic mark prediction system for a learning curriculum in which a plurality of learning items are assigned to a plurality of levels and learning is performed in order of the levels, wherein
the scholastic mark prediction system comprises a hardware processor,
the hardware processor performs
extracting, based on relevance information indicating relevance between the plurality of learning items, learning information on a learning item out of learning information on a target learner, the learning item being relevant to a learning item subjected to prediction, among the plurality of learning items, and being assigned to a preceding level that precedes a level to which the learning item subjected to prediction is assigned, and
predicting, based on the extracted learning information, a scholastic mark of the target learner for the learning item subjected to prediction, and outputting a result of the prediction.

2. The scholastic mark prediction system according to claim 1, wherein
predicting the scholastic mark of the target learner for the learning item subjected to prediction and outputting the result of the prediction, includes
inputting the extracted learning information to a learning model, to predict the scholastic mark of the target learner for the learning item subjected to prediction,
wherein the learning model is generated for each of a plurality of learners, by learning a relation between
the learning information on the learning item that is relevant to the learning item subjected to prediction and that is assigned to the preceding level that precedes the level to which the learning item subjected to prediction is assigned, and
the scholastic mark of the learner for the learning item subjected to prediction.

3. The scholastic mark prediction system according to claim 1, wherein the learning information is information for each unit of study.

4. The scholastic mark prediction system according to claim 1, wherein
the result of the prediction includes at least one of
information indicating whether the scholastic mark of the target learner is higher than a predetermined standard,
information indicating a possibility that the scholastic mark is higher than the predetermined standard, and
information indicating a degree of understanding, by the target learner, of the learning item subjected to prediction.

5. The scholastic mark prediction system according to claim 1, wherein
the learning information is made up of a plurality of pieces of information, and
the hardware processor detects information regarding a degree of influence of the information on the result of the prediction, and outputs the detected information.

6. The scholastic mark prediction system according to claim 5, wherein the hardware processor outputs, based on the information regarding the degree of influence, a comment or information regarding a teaching material.

7. The scholastic mark prediction system according to claim 1, wherein, for the learning item, the hardware processor presents the result of the prediction for the target learner, and an actual value of the scholastic mark of the target learner, in a manner that the result of the prediction and the actual value can be compared with each other.

8. The scholastic mark prediction system according to claim 1, wherein for the learning item, the hardware processor generates information based on the result of the prediction for the target learner and an actual value of the scholastic mark of the target learner, and presents the generated information.

9. The scholastic mark prediction system according to claim 1, wherein the learning item for the preceding level includes a learning item of a course of study different from a course of study of the learning item subjected to prediction.

10. A scholastic mark prediction method implemented by a computer, comprising:
accessing, by a hardware processor of the computer, a learning curriculum in which a plurality of learning items are assigned to a plurality of levels and learning is performed in order of the levels;
extracting, by the hardware processor, based on relevance information indicating relevance between the plurality of learning items, learning information on a learning item out of learning information on a target learner, the learning item being relevant to a learning item subjected to prediction, among the plurality of learning items, and being assigned to a preceding level that precedes a level to which the learning item subjected to prediction is assigned; and
predicting, by the hardware processor, based on the extracted learning information, a scholastic mark of the target learner for the learning item subjected to prediction, and outputting, by the hardware processor, a result of the prediction.

11. The scholastic mark prediction method according to claim 10, wherein
predicting the scholastic mark of the target learner for the learning item subjected to prediction and outputting the result of the prediction, includes
inputting the extracted learning information to a learning model, to predict the scholastic mark of the target learner for the learning item subjected to prediction,
wherein the learning model is generated for each of a plurality of learners, by learning a relation between
the learning information on the learning item that is relevant to the learning item subjected to prediction and that is assigned to the preceding level that precedes the level to which the learning item subjected to prediction is assigned, and
the scholastic mark of the learner for the learning item subjected to prediction.

12. The scholastic mark prediction method according to claim 10, wherein the learning information is information for each unit of study.

13. The scholastic mark prediction method according to claim 10, wherein
the result of the prediction includes at least one of
information indicating whether the scholastic mark of the target learner is higher than a predetermined standard,
information indicating a possibility that the scholastic mark is higher than the predetermined standard, and
information indicating a degree of understanding, by the target learner, of the learning item subjected to prediction.

14. The scholastic mark prediction method according to claim 10, wherein
the learning information is made up of a plurality of pieces of information, and
the scholastic mark prediction method further comprises detecting information regarding a degree of influence of the information on the result of the prediction, and outputting the detected information.

15. The scholastic mark prediction method according to claim 14, further comprising outputting, based on the information regarding the degree of influence, a comment or information regarding a teaching material.

16. The scholastic mark prediction method according to claim 10, further comprising, for the learning item, presenting the result of the prediction for the target learner, and an actual value of the scholastic mark of the target learner, in a manner that the result of the prediction and the actual value can be compared with each other.

17. The scholastic mark prediction method according to claim 10, further comprising, for the learning item, generating information based on the result of the prediction for the target learner and an actual value of the scholastic mark of the target learner, and presenting the generated information.

18. The scholastic mark prediction method according to claim 10, wherein the learning item for the preceding level includes a learning item of a course of study different from a course of study of the learning item subjected to prediction.

19. A non-transitory computer-readable recording medium having a program stored thereon for causing a computer to perform the scholastic mark prediction method according to claim 10.
